(19) United States
(12) Patent Application Publication
(10) Pub. No.: US 2016/0326606 A1
(43) Pub. Date: Nov. 10, 2016

(54) METHODS FOR PRODUCING IMPROVED STEELS BY INJECTING IRON CONTAINING BY-PRODUCTS OF AN IRON ORE PRODUCTION PROCESS INTO LIQUID STEEL

(71) Applicant: Saudi Basic Industries Corporation, Riyadh (SA)

(72) Inventor: Othman N. AL-ZEGHAIBI, Jubail (SA)

(21) Appl. No.: 15/109,493

(22) PCT Filed: Jan. 29, 2015
(86) PCT No.: PCT/IB2015/050663

§ 371 Date: Jul. 1, 2016

Related U.S. Application Data
(60) Provisional application No. 61/934,595, filed on Jan. 31, 2014.

(51) Int. Cl. C21B 13/14; C22C 35/00; F27D 11/08; C21B 13/00; F27B 14/06; F27B 14/08; C22C 38/00; C21C 5/52

(52) U.S. Cl. CPC C21B 13/143; C22C 38/004; C22C 38/001; C22C 35/005; C21C 5/5217; C21C 5/5229; C21C 5/527; C21B 13/004; F27B 14/06; F27B 14/0806; F27D 11/08; F27B 2014/002

(57) ABSTRACT

Disclosed herein are methods and compositions for producing improved steels comprising injecting iron containing by-products of an iron ore production process into a liquid steel, wherein the iron containing by-products of an iron ore production process further comprise direct reduced iron (DRI) fines. The resulting improved steel exhibits lower nitrogen content than one measured for a substantially identical reference composition produced in the absence of the direct reduced iron fines.

### CROSS-REFERENCE TO RELATED APPLICATIONS

This application claims the benefit of and priority to U.S. Application No. 61/934,595 filed Jan. 31, 2014, which is hereby incorporated by reference in its entirety.

### FIELD OF INVENTION

The present invention relates to methods for producing improved steel by injecting iron containing by-products of an iron ore production process into liquid steel.

### BACKGROUND OF THE INVENTION

In the iron making and steel making industry, the demand for clean steel with little impurities has been increasing due to stringent quality control requirements. The removal of gaseous impurities to improve the quality of steel is one of the most important aspects of steel making technology. Among the three gaseous components, such as nitrogen, hydrogen and oxygen that are commonly present in steel products, nitrogen draws special attention due to its effect on the mechanical properties of steel. Although for some steels of special purposes, nitrogen is often beneficial for strengthening and grain refinement, its control is essential for plain carbon steel in order to produce steel with desired mechanical properties and weldability.

A direct reduced iron (DRI) and/or an iron scrap are often used as raw materials in a steel production process. The direct reduced iron is produced by reducing the natural iron ores, i.e., by removal of oxygen from iron ore without melting. In the direct reduction process, the direct reduced iron is produced in the form of solid pellets and lumps. In most cases, this direct reduced iron (in the form of pellets and lumps) is fed (with or without scrap) into the furnace for steelmaking. The direct reduced iron fines generated either from direct reduced iron processes or by attrition in transport and handling, however, are screened as waste. While the direct reduced iron contains significant quantities of the elements such as carbon and oxygen that are beneficial in nitrogen removal, this benefit is largely lost when the direct reduced iron (DRI) enters a steel bath in the form of pellets and lumps.

Traditionally, the blast furnace/basic oxygen furnace steel making route has been favored over the electric arc furnace (EAF) route for the production of high-quality steels, partially because of the lower nitrogen level. However, these traditional steelmaking processes are highly energy intensive and not cost effective.

Accordingly, there remains a need for iron making and steel making methods and materials that can provide high quality (i.e. low nitrogen content) steel while maximizing raw materials, cost efficiency, and energy consumption savings. This need and other needs are satisfied by the various aspects of the present disclosure.

### SUMMARY OF THE INVENTION

In accordance with the purposes of the invention, as embodied and broadly described herein, the invention provides a method for producing steel, comprising the steps: a) providing a feed of a metallic scrap comprising steelmaking raw materials; b) introducing the feed of the metallic scrap comprising steelmaking raw materials into a furnace; c) bringing the furnace to conditions effective to produce a first liquid steel; d) providing a feed of iron containing by-products of an iron ore production process; e) injecting the feed of iron containing by-products into the first liquid steel at a flow rate in the range from about 20 to about 500 kg/min to form a blend; and f) subjecting the blend formed in step e) to conditions effective to produce a second liquid steel.

In one exemplary aspect, the iron containing by-products of an iron ore production process comprise direct reduced iron (DRI) fines.

In a still further exemplary aspect, the invention relates to a steel comprising: a) carbon present in an amount in the range from about 400 ppm to about 1500 ppm; b) a total iron content present in the amount in the range from greater than about 95 wt % to less than about 100 wt %; c) an iron oxide present in amount of less than about 600 ppm; and d) nitrogen present in an amount of less than about 120 ppm.

In further aspects, the invention also relates to articles comprising the disclosed steel and steel made from the disclosed methods for producing the steel.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is no way intended that nay method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying FIGURES, which are incorporated in and constitute a part of this specification, illustrate several aspects and together with the description serve to explain the principles of the invention.

FIG. 1 shows an exemplary schematic diagram for processing liquid steel according to the invention, wherein direct reduced iron (DRI) fines are injected into liquid steel in an electric arc furnace (EAF) unit.

### DETAILED DESCRIPTION OF THE INVENTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, exemplary methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. DEFINITIONS

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a carbonaceous material” includes mixtures of two or more carbonaceous materials.

As used herein, the term “combination” is inclusive of blends, mixtures, alloys, reaction products, and the like.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (“wt %”) of a component, unless specifically stated to the contrary, is based on the total weight of the formulation or composition in which the component is included. For example if a particular element or component in a composition or article is said to have 8% by weight, it is understood that this percentage is relative to a total compositional percentage of 100% by weight.

As used herein, the terms “ppm” and “parts per million” are used interchangeably and refer to a unit of measure of the amount of disclosed elements in the total composition in terms of a ratio between the number of parts of disclosed elements to a million parts of the total composition.

As used herein, the term or phrase “effective,” “effective amount,” or “conditions effective to” refers to such amount or condition that is capable of performing the function or property for which an effective amount is expressed. As will be pointed out below, the exact amount or particular condition required will vary from one aspect to another, depending on recognized variables such as the materials employed and the processing conditions observed. However, it should be understood that an appropriate effective amount will be readily determined by one of ordinary skill in the art using only routine experimentation.

As used herein, the term “direct reduction process of natural iron ores” refers to a process of reducing natural iron ores to a metallic iron at the temperatures below the melting point of iron, in the presence of one or more reducing gases. For example, and without limitation, in some aspects of the invention, the reducing gases can comprise a hydrogen gas (H₂), a carbon monoxide gas (CO), or hydrocarbon-rich gases, or any mixture thereof. In one aspect, the product of such solid state process is called a direct reduced iron (DRI).

As used herein, the terms “foamy slag layer” or “slag” can be used interchangeably and refer to a by-product of the steelmaking process, which separates the desired metal fraction from the unwanted fraction. For example and without limitation, in some aspects of the invention, for exemplary purposes slag can comprise metal oxides, limestone, or dolomite, or any combination thereof. In still further aspects of the invention, the slag can further comprise any one or more impurities present in steelmaking raw materials.

As used herein, the term “substantially identical reference product” refers to a product produced by the substantially identical methods to the inventive product by providing essentially of substantially the same proportions and components but in the absence of a stated component. For example and without limitation, in some aspects of the invention, for purposes of comparison to a corresponding reference product, as used herein, corresponding reference product is formed essentially by the same method steps as the inventive composition but for the absence of the direct reduced iron fines (DRI) fines.

Each of the materials disclosed herein are either commercially available and/or the methods for the production process thereof are known to those of ordinary skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. METHOD FOR PRODUCING STEEL

As briefly described above, the present disclosure relates, in one aspect, to a method for producing steel. In one aspect, the method comprises the steps of: a) providing a feed of a metallic scrap comprising steelmaking raw materials; b) introducing the feed of the metallic scrap comprising steelmaking raw materials into a furnace; c) bringing the furnace to conditions effective to produce a first liquid steel; d) providing a feed of iron containing by-products of an iron ore production process; e) injecting the feed of iron containing by-products into the first liquid steel at a flow rate in the range from about 20 to about 500 kg/min to form a blend; and f) subjecting the blend formed in step e) to conditions effective to produce a second liquid steel.

In one aspect, the feed of the metallic scrap comprising steelmaking raw materials further comprises recyclable by-products of a steelmaking process, by-products of the manufacture of steel-containing parts or goods, or materials discarded after use in the form of consumer goods, or any combination thereof. In one aspect, metallic scrap can further comprise parts of vehicles, building supplies, surplus materials, or a combination thereof. In another aspect, the feed of the metallic scrap comprising steelmaking raw materials can even further comprise a direct reduced iron (DRI).

In one aspect, the direct reduced iron (DRI) can have any desired shape and form. In one aspect, the DRI can comprise sponges, pellets, lumps, briquettes, or any combination thereof.

In one aspect, the direct reduced iron (DRI) can have any desired composition. In one aspect, the direct reduced iron (DRI) comprises a metallic iron, iron oxides, carbon, phosphor, sulfur, silicon oxide, aluminum oxide, nitrogen, a gangue, or any combination thereof. In one aspect, the iron oxides present in the direct reduced iron can further comprise an oxide of Fe(II), an oxide of Fe(III), and an oxide of Fe(II, III), or any combination thereof.

In one aspect, the direct reduced iron (DRI) comprises a total iron content present in an amount in the range from greater than about 80 wt % to less than about 100 wt % based on the total weight of the DRI, including exemplary values of greater than about 85 wt %, greater than about 90 wt %, greater than about 95 wt %, or greater than about 99 wt %. In still further aspects, a total iron content is present in exemplary amounts of less than about 100 wt %, less than about 98 wt %, less than about 95 wt %, less than about 90 wt %, or less than about 85 wt %. In still further aspects, the DRI can comprise a total iron content in an amount in any range derived from any two of the above listed exemplary values. For example, the DRI can comprise a total iron content that is present in an amount ranging from about 87 wt % to about 97.0 wt %, based on the total weight of the DRI. In still another aspect, the DRI can comprise a total iron content in an amount ranging from about 90 wt % to 94 wt %, based on the total weight of the DRI.

In one aspect, the DRI comprises a metallic iron that is present in an amount in the range from greater than about 80 wt % to less than about 100 wt % based on the total iron content in the DRI fines, including exemplary values of greater than about 85 wt %, greater than about 90 wt %; greater than about 95 wt %, or greater than about 98 wt %. In still further aspects, a metallic iron can be present in exemplary amounts of less than about 100 wt %, less than about 98 wt %, less than about 95 wt %, less than about 90 wt %, or less than about 85 wt % based on the total iron content in the DRI fines. In still further aspects, the DRI can comprise a metallic iron that is present in any range derived from any two of the above listed exemplary values. For example, the DRI can comprise a metallic iron in an amount ranging from about 87 wt % to about 97.0 wt %, based on the total iron content in the DRI. In still another aspect, the DRI can comprise a metallic iron present in an amount ranging from about 90 wt % by weight to about 94 wt %, based on the total iron content in the DRI.

In one aspect, the direct reduced iron comprises carbon in an amount in the range from greater than 0 wt % to about 5 wt %, based on the total weight of the DRI, including exemplary values of about 0.5 wt %, 1 wt %, 1.5 wt %, 2 wt %, 2.5 wt %, 3 wt %, 3.5 wt %, 4 wt %, and about 4.5 wt %. In still further aspects, the DRI can comprise carbon present in any range derived from any two of the above listed exemplary values. For example, the DRI can comprise carbon present in an amount ranging from about 0.2 wt % to about 4.7 wt %, based on the total weight of the DRI. In still another aspect, the DRI can comprise carbon present in an amount ranging from about 1.3 wt % to about 2.0 wt %, based on the total weight of the DRI.

In one aspect, the DRI can comprise sulfur that is present in an amount in the range from greater than 0 ppm to about 300 ppm, including exemplary values of about 10 ppm, 30 ppm, 50 ppm, 100 ppm, 120 ppm, 150 ppm, 180 ppm, 200 ppm, 220 ppm, 250 ppm, and about 280 ppm. In still further aspects, the DRI can comprise sulfur in any range derived from any two of the above listed exemplary values. For example, the DRI can comprise sulfur present in an amount ranging from about 10 ppm to about 125 ppm. In still another aspect, the DRI can comprise sulfur in an amount ranging from about 30 ppm to about 200 ppm.

In one aspect, the DRI can comprise phosphorus that is present in an amount in the range from greater than 0 wt % to about 0.5 wt % based on the total weight of the DRI, including exemplary values of about 0.05 wt %, 0.1 wt %, 0.15 wt %, 0.2 wt %, 0.25 wt %, 0.3 wt %, 0.35 wt %, 0.40 wt %, and about 0.45 wt %. In still further aspects, the DRI can comprise phosphorous present in any range derived from any two of the above listed exemplary values. For example, the DRI can comprise phosphorus present in an amount ranging from about 0.13 wt % to about 0.45 wt % based on the total weight of the DRI.

In one aspect, the direct reduced iron (DRI) can comprise a gangue that is present in an amount in the range from greater than 0 wt % to about 10 wt % based on the total weight of the DRI, including exemplary values of about 1 wt %, 2 wt %, 3 wt %, 4 wt %, 5 wt %, 6 wt %, 7 wt %, 8 wt %, and about 9 wt %. In still further aspects, the DRI can comprise a gangue present in any range derived from any two of the above listed exemplary values. For example, the DRI can comprise a gangue in an amount ranging from about 7.5 wt % to about 10 wt % based on the total weight of the DRI. In still another aspect, the DRI can comprise a gangue in an amount ranging from about 3 wt % to about 9.8 wt % based on the total weight of the DRI.

In one aspect, the direct reduced iron (DRI) can comprise nitrogen in an amount from 0 ppm to about 50 ppm, including exemplary values of about 5 ppm, 10 ppm, 15 ppm, 20 ppm, 25 ppm, 30 ppm, 35 ppm, 40 ppm, or about 45 ppm. In another aspect, the direct reduced iron (DRI) comprises substantially less nitrogen than the metallic scrap consisting of recyclable materials from product manufacturing and consumption. In yet another aspect, the direct reduced iron (DRI) comprises substantially no nitrogen. In still another aspect, the direct reduced iron (DRI) comprises no nitrogen.

In one aspect, the feed of iron containing by-products of an iron ore production process comprises a mill scale, iron oxide fines, direct reduced iron (DRI) fines, bag house dust, direct reduced slurry, dried metallurgical slurries, fine ores, iron carbide, or any combination thereof. In another aspect, the feed of iron containing by-products of an iron ore production process comprises the direct reduced iron (DRI) fines.

In one aspect, the direct reduced iron fines are generated from the direct reduced iron processes. In another aspect, the direct reduced iron fines are generated by attrition in transport and handling of the direct reduced iron. In one aspect, the direct reduced iron fines have an average particle size from about 0.1 mm to about 12 mm, including exemplary values of about 0.5 mm, 1 mm, 2 mm, 3 mm, 4 mm, 5 mm, 6 mm, 7 mm, 8 mm, 9 mm, 10 mm, and about 11 mm. In yet another aspect, the direct reduced iron fines have an average particles size of less than or equal to about 6 mm, less than or equal to about 5 mm, less than or equal to about 4 mm, less than or equal to about 3 mm, less than or equal to about 2 mm, less than or equal to about 1 mm. In still further aspects, the direct reduced iron fines have an average particles size in any range derived from any two of the above listed exemplary values. For example, the average particles size can be in the range from about 0.6 mm to about 3.5 mm. In still another aspect, the average particle size can be in any range from about 1 mm to about 6 mm. In a yet further aspect, the direct reduced iron fines can comprise substantially small fines with an average size equal or less than about 6 mm. In one aspect, the particle size can be measured according to various standard methods available in the art.

In various aspects of this invention, the direct reduced iron fines have a moisture content of less than or equal to about 0.3%, including exemplary values of less than or equal to about 0.25%, 0.2%, 0.15%, 0.1%, 0.05%, or about 0.01%. In still further aspects, the direct reduced iron fines have a moisture content in any range derived from any two of the above listed exemplary values. For example, the moisture content can be in the range from about 0.25% to about 0.1%. In still another aspect, the moisture content can be in any range from about 0.3% to about 0.01%.

In one aspect, the direct reduced iron (DRI) fines can have any desired composition. In another aspect, the direct reduced iron (DRI) fines can comprise metallic iron, iron oxides, carbon, phosphor, sulfur, silicon oxide, aluminum oxide, nitrogen, a gangue, or any combination thereof. In one aspect, the iron oxides can comprise an oxide of Fe(II), an oxide of Fe(III), and an oxide of Fe(II, III), or any combination thereof.

In one aspect, the DRI fines comprise a total iron content present in an amount in the range from greater than about 80 wt % to less than about 100 wt % based on the total weight of the DRI fines, including exemplary values of greater than about 85 wt %, greater than about 90 wt %, greater than about 95 wt %, or greater than about 99 wt %. In still further aspects, a total iron content is present in exemplary amounts of less than about 100 wt %, less than about 98 wt %, less than about 95 wt %, less than about 90 wt %, or less than about 85 wt %. In still further aspects, the DRI fines can comprise a total iron content present in any range derived from any two of the above listed exemplary values. For example, the direct reduced iron fines can comprise a total iron content present in an amount ranging from about 86 wt % to about 97.0 wt %, based on the total weight of the DRI fines. In still another aspect, the DRI fines can comprise a total iron content in an amount ranging from about 89 wt % to about 95 wt %, based on the total weight of the DRI fines.

In one aspect, the direct reduced iron fines comprise a metallic iron that is present in an amount in the range from greater than about 80 wt % to less than about 100 wt % based on the total iron content in the DRI fines, including exemplary values of greater than about 85 wt %, greater than about 90 wt %; greater than about 95 wt %, or greater than about 98 wt %. In still further aspects, a metallic iron can be present in an amount including exemplary values of less than about 100 wt %, less than about 98 wt %, less than about 95 wt %, less than about 90 wt %, or less than about 85 wt % based on the total iron content in the DRI fines. In still further aspects, the DRI fines can comprise a metallic iron present in any range derived from any two of the above listed exemplary values. For example, the DRI fines can comprise a metallic iron present in an amount ranging from about 87 wt % to about 97.0 wt %, based on the total iron content in the DRI fines. In still another aspect, the DRI fines can comprise a metallic iron present in an amount ranging from about 90 wt % to about 96 wt %, based on the total iron content in the DRI fines.

In various aspects of the invention, the direct reduced iron fines comprise significant quantities of carbon and oxygen. For example and without limitation, in one aspect, the direct reduced iron fines comprise carbon in an amount in the range from greater than 0 wt % to about 5 wt %, based on the total weight of the DRI fines, including exemplary values of about 0.5 wt %, 1 wt %, 1.5 wt %, 2 wt %, 2.5 wt %, 3 wt %, 3.5 wt %, 4 wt %, and about 4.5 wt %. In still further aspects, the DRI fines can comprise carbon in any range derived from any two of the above listed exemplary values. For example, the DRI fines can comprise carbon present in an amount ranging from about 0.2 wt % to about 4.7 wt %, based on the total weight of the DRI fines. In still another aspect, the DRI fines can comprise carbon present in an amount ranging from about 1.3 wt % to about 2.0 wt %, based on the total weight of the DRI fines. In a yet further aspect, the DRI fines can comprise carbon present in amount greater than about 1.5 wt %, but less than about 5 wt % based on the total weight of the DRI fines.

In another aspect, the direct reduced iron fines can comprise oxygen that is present in an amount in the range from greater than 0 wt % to about 4 wt %, including exemplary values of about 0.2 wt %, 0.5 wt %, 1 wt %, 1.5 wt %, 2 wt %, 2.5 wt %, 3 wt %, and about 3.5 wt %. In still further aspects, the DRI fines can comprise oxygen that is present in any range derived from any two of the above listed exemplary values. For example, the DRI fines can comprise oxygen that is present in an amount ranging from about 0.6 wt % to about 2.0 wt %, based on the total weight of the DRI fines. In still another aspect, the DRI fines can comprise oxygen that is present in an amount ranging from about 1 wt % to about 3.0 wt %, based on the total weight of the DRI fines. In a yet further aspect, the DRI fines can comprise oxygen in a form of iron oxides. In another aspect, the DRI fines can comprise oxygen in a form of aluminum oxide, or silicon oxide, or any combination thereof. In a yet further aspect, the DRI fines can comprise oxygen in any oxide form.

In one aspect, the direct reduced iron (DRI) fines can comprise sulfur that is present in an amount in the range from greater than 0 ppm to about 300 ppm, including exemplary values of about 10 ppm, 30 ppm, 50 ppm, 100 ppm, 120 ppm, 150 ppm, 180 ppm, 200 ppm, 220 ppm, 250 ppm, and about 280 ppm. In still further aspects, the DRI fines can comprise sulfur that is present in any range derived from any two of the above listed exemplary values. For example, the DRI fines can comprise sulfur that is present in an amount ranging from about 10 ppm to about 125 ppm. In still another aspect, the DRI fines can comprise sulfur in an amount ranging from about 30 ppm to about 200 ppm.

In one aspect, the direct reduced iron fines can comprise phosphorus that is present in an amount in the range from greater than 0 wt % to about 0.5 wt % based on the total weight of the DRI fines, including exemplary values of about 0.05 wt %, 0.1 wt %, 0.15 wt %, 0.2 wt %, 0.25 wt %, 0.3 wt %, 0.35 wt %, 0.40 wt %, or about 0.45 wt %. In still further aspects, the direct reduced iron fines can comprise phosphorous present in any range derived from any two of the above listed exemplary values. For example, the DRI fines can comprise phosphorus present in an amount ranging from about 0.13 wt % to about 0.45 wt %.

In one aspect, the direct reduced iron fines can comprise a gangue that is present in an amount in the range from greater than 0 wt % to about 10 wt % based on the total weight of the DRI fines, including exemplary values of about 1 wt %, 2 wt %, 3 wt %, 4 wt %, 5 wt %, 6 wt %, 7 wt %, 8 wt %, or about 9 wt %. In still further aspects, the DRI fines can comprise a gangue present in any range derived from any two of the above listed exemplary values. For example, the DRI can comprise a gangue present in an amount ranging from about 2.8 wt % to about 7 wt %. In still another aspect, the DRI fines can comprise a gangue present in an amount ranging from about 2.8 wt % to about 4 wt % based on the total weight of the DRI fines.

In one aspect, the direct reduced iron (DRI) fines can comprise nitrogen that is present in amount from 0 ppm to about 50 ppm, including exemplary values of about 5 ppm, 10 ppm, 15 ppm, 20 ppm, 25 ppm, 30 ppm, 35 ppm, 40 ppm, or about 45 ppm. In yet another aspect, the direct reduced iron (DRI) fines can comprise substantially no nitrogen. In yet another aspect, the direct reduced iron (DRI) fines can comprise no nitrogen.

In one aspect and according to the methods disclosed herein, the feed of the metallic scrap comprising steelmaking raw materials and the feed of iron containing by-products of an iron ore production process can be introduced into the furnace separately, or in combination, using a conveyor belt, baskets, DRI fine injection, or any combination thereof. In one aspect, the feed of the metallic scrap comprising steelmaking raw materials can be introduced into the furnace using a conveyor belt. In another aspect, the feed of iron containing by-products of an iron ore production process can be introduced into the furnace using a conveyor belt. In yet another aspect, the materials can be fed into the furnace by any means known to one of ordinary skill in the art.

In various aspects of this invention, the method for producing a steel comprises providing a feed of the metallic scrap comprising steelmaking raw materials and introducing the feed into a furnace. In one aspect, the furnace is a blast furnace (BF), a basic oxygen furnace (BOF), or an electric arc furnace (EAF), or any combination thereof. In another aspect, the furnace is an electric arc furnace. In various aspects of this invention, the electric arc furnace is used for melting materials that has been fed into the furnace. In one aspect, and as one of ordinary skill in the art would appreciate, the energy required for melting in the electric arc furnace, is introduced by means of an electric current via one or more electrodes, and the heat is transferred to the metallic charge via an electric arc. In various aspects of the invention, the materials fed into the electric arc furnace have to avoid contact with the electrodes and damage the same when charging the furnace.

In one aspect, the methods for producing the first liquid steel comprise introducing the feed of the metallic scrap comprising steelmaking raw materials into an empty furnace. In another aspect, the methods can further comprise bringing the furnace to conditions effective to produce a first liquid steel. In one aspect, conditions effective to produce the first liquid steel comprise melting down the introduced feed by means of igniting the electrodes in the electric arc furnace. In another aspect, conditions effective to produce the first liquid steel comprise bringing the furnace to a temperature in the range from about 1,400° C. to about 1,700° C., including exemplary values of about 1,420° C., 1,450° C., 1,480° C., 1,500° C., 1,520° C., 1,550° C., 1,580° C., 1,600° C., 1,620° C., 1,650° C., and about 1,680° C. In still further aspects, the furnace can be brought to a temperature in any range derived from any two of the above listed exemplary values. For example, the furnace temperature can be in the range from about 1,450° C. to about 1,650° C. In still another aspect, the temperature can be in the range from about 1,550° C. to about 1,700° C. It should also be appreciated that the furnace can be maintained at the desired temperature or range of temperatures for any desired period of time. Such durations will be readily known to one of ordinary skill in the art in view of this disclosure.

In various aspects of this invention, the iron containing by-products of an iron ore production process are injected into the first liquid steel by any means known to one of ordinary skill in the art. In one aspect, the iron containing by-products of an iron ore production process are injected by means of a charging tube. In one aspect, the iron containing by-products of iron ore production process further comprise the direct reduced iron fines. In one aspect, the charging tube can comprise a downpipe, a lance, a compressed-fine wire, or any combination thereof. In various aspects of this invention, the lance can have any conventionally configured orifice known to one of ordinary skill in the art, as long as the orifice aperture has no corners and sharp-edged transitions. In a further aspect, at least one lance can be used to inject the iron containing by-products of an iron ore production process. In a yet further aspect, two or more lances can be used to inject the iron containing by-products of an iron ore production. In various aspects of this invention, the iron containing by-products of an iron ore production can further comprise the direct reduced iron fines. In one aspect, at least one lance can be used to inject the direct reduced iron fines.

In one aspect, the lance utilized in this invention can have an internal diameter in the range from about 30 to about 1500 mm, including exemplary values of about 40 mm, 50 mm, 60 mm, 70 mm, 80 mm, 90 mm, 100 mm, 120 mm, 150 mm, 180 mm, 200 mm, 250 mm, 300 mm, 400 mm, 500 mm, 600 mm, 700 mm, 800 mm, 900 mm, 1000 mm, 1100 mm, 1200 mm, 1300 mm, or about 1400 mm. In still further aspects, the internal diameter of the lance can be in any range derived from any two of the above listed exemplary values. For example, the internal diameter can be in the range from about 30 mm to about 100 mm. In still another aspect, the internal diameter can be in the range from about 300 mm to about 600 mm. In a further aspect and without limitation, if two or more lances are used, each of the lances can have the same or a different internal diameter.

In one aspect, the iron containing by-products of an iron ore production process comprising the direct reduced iron fines can be injected through the lance by means of gravity. In another aspect, at least one pneumatic lance can be used. In yet another aspect, any combination of pneumatic and gravity based lances can be used. In a further aspect, two or more pneumatic lances can be used.

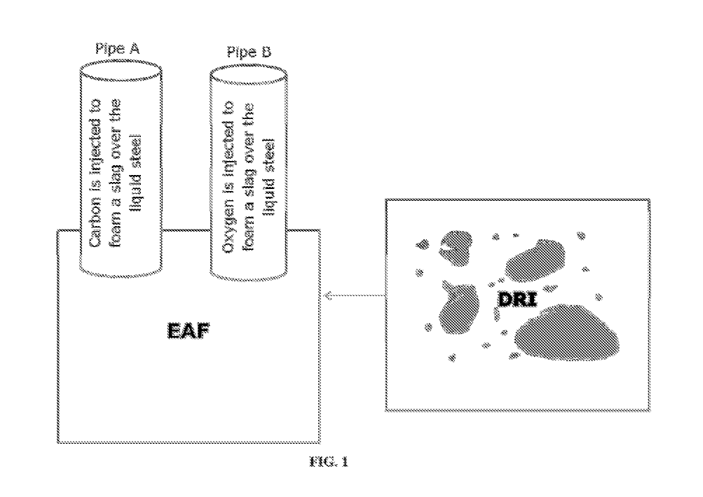

In one aspect, the iron containing by-products of an iron ore production process comprising the direct reduced iron fines can be injected into the first liquid steel without a carrier gas. In another aspect, the iron containing by-products of an iron ore production process comprising the direct reduced iron fines can be injected into the first liquid steel using a carrier gas. In one aspect, the carrier gas can comprise a carbon feed, inert gas, or any combination thereof. In one aspect, an exemplary inert gas that can be used includes argon. In yet another aspect and without limitation, the carbon feed can be gaseous, solid, or liquid. An exemplary carbon feed gas can include carbon dioxide. In one aspect, the iron containing by-products of an iron ore production process comprising the direct reduced iron fines can be injected into the first liquid steel in combination with a carbon feed. In a further aspect, the iron containing by-products of an iron ore production process comprising the direct reduced iron fines can be injected into the first liquid steel in combination with the carbon feed, wherein the direct reduced iron fines and the carbon feed are injected using separate lances, and wherein the lances can comprise pneumatic lances. In a yet further aspect, the iron containing by-products of an iron ore production process comprising the direct reduced iron fines and the carbon feed are injected utilizing a carbon feed pneumatic lance. FIG. 1 shows an exemplary schematic diagram for processing liquid steel, wherein direct reduced iron (DRI) fines are injected into liquid steel in an electric arc furnace. The direct reduced iron (DRI) fines can be injected into liquid steel in combination with the carbon feed, such as in pipe/lance A, or separately from the carbon feed, relatively deeply below the surface of the liquid steel.

In various aspects of the present invention, the iron containing by-products of an iron ore production process are injected into the first liquid steel at a flow rate from about 20 kg/min to about 500 kg/min to form a blend. In further aspects, the iron containing by-products can be injected at exemplary flow rates of about 30 kg/min, 40 kg/min, 50 kg/min, 60 kg/min, 70 kg/min, 80 kg/min, 90 kg/min, 100 kg/min, 120 kg/min, 150 kg/min, 200 kg/min, 250 kg/min, 300 kg/min, 350 kg/min, 400 kg/min, and about 450 kg/min. In still further aspects, the iron containing by-products can be injected at the flow rates in any range derived from any two of the above listed exemplary values. For example, the iron containing by-products can be injected at flow rates from about 20 kg/min to about 300 kg/min. In still another aspect, the iron containing by-products can be injected at flow rates from about 20 kg/min to about 100 kg/min. In one aspect, the iron containing by-products of an iron ore production process can comprise the direct reduced fines.

In one aspect, and as one of ordinary skill in the art would readily appreciate, the lance used to inject the iron containing by-products of an iron ore production process comprising the direct reduced iron fines can be positioned in the furnace in any direction, or location effective to produce a desired steel. In one aspect, the lance can be positioned vertically. In another aspect, the lance can be positioned in such a way that a lance orifice is kept above a foamy layer slag, such that the iron containing by-products of an iron ore production process comprising the direct reduced iron fines can be dispensed above the foamy slag. In yet another aspect, the lance can be positioned in such a way that a lance orifice is within a foamy layer slag, such that the iron containing by-products of an iron ore production process comprising the direct reduced iron fines can be dispensed within the foamy slag. In further aspects, the lance can be positioned in such a way that a lance orifice is within the first liquid steel, such that the iron containing by-products of an iron ore production process comprising the direct reduced iron fines can be dispensed within the first liquid steel. In these aspects, the lance can be positioned within the first liquid steel at a depth below the liquid steel surface in the range of from, for example, about 30 mm to about 1500 mm, including exemplary values of about 50 mm, 100 mm, 200 mm, 300 mm, 400 mm, 500 mm, 600 mm, 700 mm, 800 mm, 900 mm, 1000 mm, 1100 mm, 1200 mm, 1300 mm, and about 1400 mm. In still further aspects, the lance can be positioned in the first liquid steel at a depth below the liquid steel surface in any range derived from any two of the above listed exemplary values. For example, the depth can be in the range from about 50 mm to about 300 mm. In still another aspect, the depth can be in the range from about 600 mm to about 1000 mm.

In various other aspects of this invention, the lance can be positioned at an angle of from about 20° to about 70° relatively to the horizontal axis of the first liquid steel. In one aspect, the lance can be positioned at exemplary angles of about 25°, 30°, 35°, 40°, 45°, 50°, 55°, 60°, and about 65° to the horizontal axis of the first liquid steel. In still further aspects, the lance can be positioned at any angle in any range derived from any two of the above listed exemplary values. For example, the lance can be positioned at an angle of from about 30° to about 50°. In still another aspect, the lance can be positioned at an angle of from about 40° to about 70°. In a yet further aspect, the lance can be positioned at an angle of about 45° relatively to the horizontal axis of the first liquid steel.

In a further aspect, the lance can be positioned at an angle from about 20° to about 70° to the horizontal axes of the first liquid steel, wherein the lance is inserted in the first liquid steel at a depth below the liquid steel surface in the range from about 30 mm to about 1500 mm. In a yet further aspect, the lance can be positioned at exemplary angles of about 25°, 30°, 35°, 40°, 45°, 50°, 55°, 60°, and about 65° to the horizontal axes of the first liquid steel, wherein the lance is inserted in the first liquid steel at exemplary depth values in the range from about 30 mm to about 1500 mm, including exemplary values of about 50 mm, 100 mm, 200 mm, 300 mm, 400 mm, 500 mm, 600 mm, 700 mm, 800 mm, 900 mm, 1000 mm, 1100 mm, 1200 mm, 1300 mm, and about 1400 mm. In still further aspects, the lance can be positioned at any angle, and inserted at any depth in any range derived from any two of the above listed exemplary values. For example, the lance can be positioned at an angle of from about 30° to about 50°, wherein the lance is inserted at a depth below the liquid steel surface in the range from about 50 mm to about 300 mm. In still another aspect, the lance can be positioned at an angle of from about 40° to about 70°, wherein the lance is inserted at a depth below the liquid steel surface in the range from about 600 mm to about 1000 mm. In a yet further aspect, the lance can be positioned at an angle of about 45°, wherein the lance is inserted at a depth below the liquid steel surface in the range from about 600 mm to about 1000 mm.

In various aspects of this invention and according to the methods described herein, the iron containing by-products of an iron ore production process comprising the direct reduced iron fines are injected into the first liquid steel to form a blend. In a further aspect, disclosed herein are methods wherein a formed blend is subjected to conditions effective to produce a second liquid steel, wherein the produced second liquid steel exhibits a lower nitrogen content than one measured for a substantially identical reference composition produced in the absence of the direct reduced iron fines. For example, the second liquid steel can exhibit a lower nitrogen content than the first liquid steel.

In one aspect and without wishing to be bound by theory, it has been hypothesized that the nitrogen removal from the steel is accomplished by the formation of relatively fine carbon monoxide (CO) bubbles. In one aspect, the iron containing by-products of an iron ore production process comprising the direct reduced iron fines can comprise significant quantities of carbon and oxygen. Without wishing to be bound by theory, it is hypothesized that upon heating these elements react rapidly inside the direct reduced iron fines to form fine carbon monoxide bubbles. In another aspect, it is further hypothesized that a rapid generation of carbon monoxide from internal reduction reactions in the DRI fines commences at the temperatures above about 500° C. In yet another aspect, wherein sufficient stoichiometric oxygen from iron oxides is available for reaction with a carbon feed, the gas generation can be completed at temperatures of about 700° C. In one aspect, to prevent oxygen depletion within the fines, oxygen containing gases can be supplied to the blend of the first liquid steel and the direct reduced iron fines using a separate lance. In another aspect, the oxygen containing gases can comprise pure oxygen.

In one aspect, the blend of the first liquid steel and the iron containing by-products of the iron ore production process comprising the direct reduced iron fines is subjected to conditions effective to produce a second liquid steel. In one aspect, conditions effective to produce the second liquid steel again comprise maintaining the furnace at a temperature in the range from about 1,400° C. to about 1,700° C., including exemplary values of about 1,420° C., 1,450° C., 1,480° C., 1,500° C., 1,520° C., 1,550° C., 1,580° C., 1,600° C., 1,620° C., 1,650° C., and about 1,680° C. In still further aspects, the furnace can be kept at a temperature in any range derived from any two of the above listed exemplary values. For example, the furnace temperature can be in the range from about 1,450° C. to about 1,650° C. In still another aspect, the temperature can be in the range from about 1,550° C. to about 1,700° C.

In still further aspects, conditions effective to produce the either the first or second steel can comprise heating the furnace under a general atmospheric air environment. In another aspect, conditions effective to produce either the first or second steel can further comprise heating the furnace in a controlled environment that comprises one or more additional gases. In yet another aspect, the one or more gases can comprise an oxygen containing gas, a carbon feed, a noble gas, or any combination thereof.

Further to the above described aspects, it should also be understood that the improved second liquid steel of the present invention can be produced from a pre-manufactured steel. According to this aspect, the present invention further provides a method for making steel comprising the steps of: a) providing a first liquid steel; b) providing a feed of iron containing by-products of an iron ore production process; c) injecting the feed of iron containing by-products into the first liquid steel at a flow rate in the range from about 20 to about 500 kg/min to form a blend; and d) subjecting the blend formed in step e) to conditions effective to produce a second liquid steel.

### C. STEEL

Also disclosed herein is steel formed by the methods described above. In one aspect, the steel, as disclosed herein, comprises a) carbon present in an amount in the range from about 400 ppm to about 1500 ppm; b) a total iron content present in amount in the range from greater than about 95 wt % to less than about 100 wt %; c) an iron oxide present in an amount of less than about 600 ppm; and d) nitrogen present in an amount of less than about 120 ppm.

In one aspect, the steel formed by the methods described above can comprise carbon in an amount in the range from about 400 ppm to about 1500 ppm, including exemplary amounts of about 500 ppm, 600 ppm, 700 ppm, 800 ppm, 900 ppm, 1000 ppm, 1100 ppm, 1200 ppm, 1300 ppm, or about 1400 ppm. In still another aspect, carbon can be present in any amount in any range derived from any two of the above listed exemplary values. In a further aspect, carbon can be present in an amount in the range from about 400 ppm to about 700 ppm. In a yet further aspect, carbon can be present in an amount in the range from about 600 ppm to about 1000 ppm. In a still further aspect, carbon can be present in amount of about 600 ppm.

In one aspect, the steel can comprise a total iron content present in amount in the range from greater than about 95 wt % to less than about 100 wt %, including exemplary values of about 96 wt %, 97 wt %, 98 wt %, 99 wt %, and about 99.5 wt %. In still another aspect, the total iron content can be present in any amount in any range derived from any two of the above listed exemplary values. In a further aspect, the total iron content can be present in an amount in the range from about 95 wt % to about 98 wt %. In a yet further aspect, the total iron content can be present in an amount in the range from about 99 wt % to about 99.9 wt %. In a still further aspect, the total iron content can be present in amount of about 99 wt %.

In one aspect, the steel can comprise an iron oxide present in amount of less than about 600 ppm, including exemplary values of less than about 500 ppm, 400 ppm, 300 ppm, 200 ppm, 100 ppm. In still another aspect, the iron oxide can be present in any amount in any range derived from any two of the above listed exemplary values. In a further aspect, the iron oxide can be present in an amount of less than 500 ppm. In a yet further aspect, the iron oxide can be present in an amount of less than 400 ppm.

In another aspect, the steel can comprise nitrogen in amount of less than about 120 ppm, less than about 100 ppm, less than about 80 ppm, less than about 60 ppm, less than about 50 ppm, and less than about 40 ppm. In still another aspect, nitrogen can be present in any amount in any range derived from any two of the above listed exemplary values. In a further aspect, nitrogen can be present in an amount of less than 80 ppm. In a yet further aspect, nitrogen can be present in an amount of less than 50 ppm.

### D. ARTICLES OF MANUFACTURE

In various aspects, the disclosed steel of the present invention can be used in manufacturing any desired articles currently formed from conventional steel materials. These can include articles of any desired shape and/or size. Exemplary articles include, without limitation, long products, flat products or a combination thereof.

Optionally, in various aspects, the disclosed methods can be operated or performed on an industrial scale. In one aspect, the methods disclosed herein can be configured to produce steel on an industrial scale. For example, according to further aspects, the methods can produce batches of steel on an industrial scale. In a further aspect, the batch size can comprise any desired industrial-scale batch size.

In one aspect, the batch size can optionally be at least about 1 kg, including exemplary batch sizes of at least about 10 kg, at least about 25 kg, at least about 50 kg, at least about 100 kg, at least about 250 kg, at least about 500 kg, at least about 750 kg, at least about 1,000 kg, at least about 2,500 kg, or greater. In an additional aspect, the batch size can optionally range from about 1 kg to about 2,500 kg, such as, for example, from about 10 kg to about 1,000 kg, from about 1,000 kg to about 2,500 kg, from about 100 kg to about 500 kg, from about 500 kg to about 1,000 kg, from about 10 kg to about 100 kg, from about 100 kg to about 250 kg, from about 500 kg to about 750 kg, or from about 750 kg to about 1,000 kg.

In another aspect, the batch size can optionally be at least about 1 ton, including exemplary batch sizes of at least about 10 tons, at least about 25 tons, at least about 50 tons, at least about 100 tons, at least about 250 tons, at least about 500 tons, at least about 750 tons, at least about 1000 tons, at least about 2,500 tons, or greater. In an additional aspect, the batch size can optionally range from about 1 ton to about 2,500 tons, such as, for example, from about 10 tons to about 1,000 tons, from about 1,000 tons to about 2,500 tons, from about 100 tons to about 500 tons, from about 500 tons to about 1,000 tons, from about 10 tons to about 100 tons, from about 100 tons to about 250 tons, from about 500 tons to about 750 tons, or from about 750 tons to about 1,000 tons.

In various aspects, the disclosed methods can be operated or performed on any desired time scale or production schedule that is commercially practicable. In one aspect, the disclosed methods can produce a quantity of at least 1 ton of steel in a period of 1 day or less, including exemplary quantities of at least about 10 tons, 100 tons, 500 tons, or 1,000 tons, or 2,500 tons, or greater within the period. In a further aspect, the period of time can be 1 hour. In a still further aspect, the quantity of steel produced can range from about 1 ton to about 1,000 tons, and the period of time can range from about 1 hour to about 1 year, for example, about 10 to about 1,000 tons in a period of about 1 hour to about 1 day.

### E. ASPECTS

In various aspects, the present invention pertains to and includes at least the following aspects.

Aspect 1: A method for producing a steel, comprising the steps:
a) providing a feed of a metallic scrap comprising steelmaking raw materials;
b) introducing the feed of the metallic scrap comprising steelmaking raw materials into a furnace;
c) bringing the furnace to conditions effective to produce a first liquid steel;
d) providing a feed of iron containing by-products of an iron ore production process;
e) injecting the feed of iron containing by-products into the first liquid steel at a flow rate in the range from about 20 to about 500 kg/min to form a blend; and
f) subjecting the blend formed in step e) to conditions effective to produce a second liquid steel.

Aspect 2: The method of aspect 1, wherein the feed of the metallic scrap comprising steelmaking raw materials further comprises a direct reduced iron (DRI) comprising sponges, pellets, lumps, briquettes, or any combination thereof.

Aspect 3: The method of any of aspects 1-2, wherein the feed of iron containing by-products of an iron ore production process is provided by a conveyor belt.

Aspect 4: The method of any of aspects 1-3, wherein the iron containing by-products of an iron ore production process comprise direct reduced iron (DRI) fines.

Aspect 5: The method of any of aspects 1-4, wherein the direct reduced iron (DRI) fines comprise fines with an average size equal or smaller than about 6 mm.

Aspect 6: The method of any of aspects 1-5, wherein step e) occurs at a flow rate in the range from about 20 to about 300 kg/min.

Aspect 7: The method of any of aspects 1-6, wherein step e) occurs at a flow rate in the range from about 20 to about 100 kg/min.

Aspect 8: The method of any of aspects 1-7, wherein the produced second liquid steel exhibits lower nitrogen content than one measured for a substantially identical reference composition produced in the absence of the DRI fines.

Aspect 9: The method of any of aspects 1-8, wherein the DRI fines have a moisture content of less than about 0.3%.

Aspect 10: The method of any of aspects 1-9, wherein the DRI fines further comprise:
a) carbon in an amount in the range from greater than 0 to about 5 wt % based on the total weight of the DRI fines;
b) a total iron content in an amount greater than about 90 wt % to less than about 100 wt % based on the total weight of the DRI fines;
c) a metallic iron in an amount greater than about 80 wt % to less than about 100 wt % based on the total iron content in the DRI fines; and
d) a gangue in an amount in the range from 0 wt % to about 10 wt % based on the total weight of the DRI fines.

Aspect 11: The method of any of aspects 1-10, wherein carbon is present in an amount greater than about 1.5 wt %.

Aspect 12: The method of any of aspects 1-11, wherein the injecting step e) utilizes at least one pneumatic lance.

Aspect 13: The method of any of aspects 1-12, wherein the pneumatic lance is positioned in the first liquid steel.

Aspect 14: The method of any of aspects 1-13, wherein the pneumatic lance is positioned in the first liquid steel at a depth in the range from about 600 mm to 1000 mm.

Aspect 15: The method of any of aspects 12-14, wherein the pneumatic lance is positioned at a 45° angle relative to the horizontal axis of the first liquid steel.

Aspect 16: The method of any of aspects 1-15, wherein the DRI fines are further introduced in combination with a carbon feed.

Aspect 17: The method of any of aspects 1-16, wherein the DRI fines and the carbon feed are introduced as a combination utilizing a carbon pneumatic lance.

Aspect 18: The method of any of aspects 1-17, wherein the pneumatic lance is positioned in the first liquid steel at a depth in the range from about 600 mm to about 1000 mm, and the pneumatic lance is positioned at a 45° angle relative to the horizontal axis of the first liquid steel.

Aspect 19: The method of any of aspects 1-18, wherein the DRI fines and the carbon feed are each injected at a flow rate from about 20 to about 500 kg/min.

Aspect 20: The method of any aspects 1-19, wherein the furnace is an electrical arc furnace.

Aspect 21: The method of any aspects 1-20, wherein conditions effective to produce the second liquid steel comprise heating the blend formed in step e) at a temperature in the range of from 1,400° C. to 1,700° C.

Aspect 22: The method of any of aspects 1-21, wherein conditions effective to produce the second liquid steel comprise the heating the blend formed in step e) under a general atmospheric air environment.

Aspect 23: A method for producing steel, comprising the steps of:
a) providing a first liquid steel;
b) providing a feed of iron containing by-products of an iron ore production process;
c) injecting the feed of iron containing by-products into the first liquid steel at a flow rate in the range from about 20 to about 500 kg/min to form a blend; and
d) subjecting the blend formed in step c) to conditions effective to produce a second liquid steel.

Aspect 24: A steel comprising
a) carbon present in an amount in the range from about 400 ppm to about 1500 ppm;
b) a total iron content present in an amount in the range from greater than about 95 wt % to less than about 100 wt %;
c) an iron oxide present in an amount of less than about 600 ppm; and
d) nitrogen present in amount of less than about 120 ppm.

Without further elaboration, it is believed that one skilled in the art can, using the description herein, utilize the present invention. The following examples are included to provide addition guidance to those skilled in the art of practicing the claimed invention. The examples provided are merely representative of the work and contribute to the teaching of the present invention. Accordingly, these examples are not intended to limit the invention in any manner.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way. Appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

1. A method for producing a steel, the method comprising:
a) providing a feed of a metallic scrap comprising steelmaking raw materials;
b) introducing the feed of the metallic scrap comprising steelmaking raw materials into a furnace;
c) bringing the furnace to conditions effective to produce a first liquid steel;
d) providing a feed of iron containing by-products of an iron ore production process;
e) injecting the feed of iron containing by-products into the first liquid steel at a flow rate in the range from about 20 to about 500 kg/min to form a blend; and
f) subjecting the blend formed in step e) to conditions effective to produce a second liquid steel.

2. The method of claim 1, wherein the feed of the metallic scrap comprising steelmaking raw materials further comprises a direct reduced iron (DRI) comprising sponges, pellets, lumps, briquettes, or any combination thereof.

3. The method of claim 1, wherein the feed of iron containing by-products of an iron ore production process is provided by a conveyor belt.

4. The method of claim 1, wherein the iron containing by-products of an iron ore production process comprise direct reduced iron (DRI) fines.

5. The method of claim 4, wherein the direct reduced iron (DRI) fines comprise fines with an average size equal or smaller than about 6 mm.

6. The method of claim 1, wherein step e) occurs at a flow rate in the range from about 20 to about 300 kg/min.

7. The method of claim 1, wherein step e) occurs at a flow rate in the range from about 20 to about 100 kg/min.

8. The method of claim 4, wherein the produced second liquid steel exhibits lower nitrogen content than one measured for a substantially identical reference composition produced in the absence of the DRI fines.

9. The method of claim 4, wherein the DRI fines have a moisture content of less than about 0.3%.

10. The method of claim 4, wherein the DRI fines further comprise:
a) carbon in an amount in the range from greater than 0 to about 5 wt % based on the total weight of the DRI fines;
b) a total iron content in an amount greater than about 90 wt % to less than about 100 wt % based on the total weight of the DRI fines;
c) a metallic iron in an amount greater than about 80 wt % to less than about 100 wt % based on the total iron content in the DRI fines; and
d) a gangue in an amount in the range from 0 wt % to about 10 wt % based on the total weight of the DRI fines.

11. The method of claim 10, wherein carbon is present in an amount greater than about 1.5 wt %.

12. The method of claim 1, wherein the injecting step e) utilizes at least one pneumatic lance.

13. The method of claim 12, wherein the pneumatic lance is positioned in the first liquid steel.

14. The method of claim 13, wherein the pneumatic lance is positioned in the first liquid steel at a depth in the range from about 600 mm to 1000 mm.

15. The method of claim 12, wherein the pneumatic lance is positioned at a 45° angle relative to the horizontal axis of the first liquid steel.

16. The method of claim 4, wherein the DRI fines are further introduced in combination with a carbon feed using a carbon pneumatic lance that is positioned in the first liquid steel at a depth in the range from about 600 mm to about 1000 mm, wherein:
the pneumatic lance is positioned at a 45° angle relative to the horizontal axis of the first liquid steel or
the DRI fines and the carbon feed are each injected at a flow rate from about 20 to about 500 kg/min.

17. (canceled)

18. (canceled)

19. (canceled)

20. The method of claim 1, wherein the furnace is an electrical arc furnace.

21. The method of claim 1, wherein conditions effective to produce the second liquid steel comprise:
heating the blend formed in step e) at a temperature in the range of from 1,400° C. to 1,700° C.; or
heating the blend formed in step e) under a general atmospheric air environment.

22. (canceled)

23. A method for producing steel, the method comprising:
a) providing a first liquid steel;
b) providing a feed of iron containing by-products of an iron ore production process;
c) injecting the feed of iron containing by-products into the first liquid steel at a flow rate in the range from about 20 to about 500 kg/min to form a blend; and
d) subjecting the blend formed in step c) to conditions effective to produce a second liquid steel.

24. A steel comprising:
a) carbon present in an amount in the range from about 400 ppm to about 1500 ppm;
b) a total iron content present in an amount in the range from greater than about 95 wt % to less than about 100 wt %;
c) an iron oxide present in an amount of less than about 600 ppm; and
d) nitrogen present in amount of less than about 120 ppm.
